(19) United States
(12) Patent Application Publication
(10) Pub. No.: US 2014/0160811 A1
(43) Pub. Date: Jun. 12, 2014

(54) RAILWAY POWER CONDITIONER FOR CO-PHASE TRACTION SUPPLY SYSTEM

(71) Applicant: UNIVERSITY OF MACAU, Macau (CN)

(72) Inventors: Man Chung WONG, Macau (CN); Ning Yi DAI, Macau (CN); Keng Weng LAO, Macau (CN); Chi Kong WONG, Macau (CN)

(73) Assignee: UNIVERSITY OF MACAU, Macau (CN)

(21) Appl. No.: 13/709,236

(22) Filed: Dec. 10, 2012

(51) Int. Cl. B60M 3/00; H02M 5/42

(52) U.S. Cl. CPC B60M 3/00; H02M 5/42
USPC 363/36

(57) ABSTRACT

A railway power conditioner includes a DC-AC converter and a AC-DC converter for performing power conversion between AC power and DC power, a DC bus connected between the DC-AC converter and the AC-DC converter; a single-phase isolation transformer coupled to an output of the AC-DC converter and a coupling capacitor connected to the DC-AC converter.

### FIELD OF THE INVENTION

The present invention generally relates to the field of electric railway power supply systems, and more particularly to a railway power conditioner in railway traction applications.

### BACKGROUND OF THE INVENTION

Electric railway vehicles such as locomotives or rail coaches powered by an alternating-current (AC) supply line gets the single-phase power from a three-phase power grid via a traction transformer. It is a typical three-phase power supply system with unbalanced loadings, which introduces power quality problems such as voltage unbalance, reactive power and harmonics to the power grid.

FIG. 1 depicts a conventional fraction power supply system 100 for electric railway. A traction transformer 120 is connected to three-phase high-voltage power grid 110. The high-voltage power grid 110 is consisted of three supply lines 111, 112, and 113 and connected to a primary winding of the traction transformer 120. A secondary winding of the traction transform 120 provides two single-phase voltage outputs 122, 124 connected to a single-phase contact wire 180 and a ground line 126 connected to a grounded rail 190 of single-phase power. The two single-phase voltage outputs 122 and 124 are electrically isolated by a neutral section (NS) 130. Locomotives or rail coaches 185 are powered by the single-phase power. The traction power supply system 100 further includes an active power conditioner (APC) 140 connected between the contact wire 180 and the grounded rail 190 having one phase connected to the voltage output 122 of the traction transformer 120 and the other phase connected to the voltage output 124 of the traction transformer 120 and separated by the NS 130.

In FIG. 1, as each single-phase voltage output is connected to a respective length of contact wire 180 in length of 20 km to 30 km separated by NS 130 having hundreds meters to more than 1 km in length, power is instantaneously shut off and rapidly restored as locomotives 185 enter and leave NS 130. Such changes will cause corresponding voltage fluctuations to the high-voltage power grid 110 and the system may therefore require more expensive automatic switches and controllers for switching the supply power of the locomotive 185 at each NS 130. In addition, the traction loads are not constant due to the effects of gradients on the track, starting, stopping, shunting and the response of the driver to signals etc. As a result, the current and voltage unbalance exist at the three-phase high-voltage power grid 110.

FIG. 2 shows as a schematic view of a co-phase traction power supply system 200, which is an improved power supply system with a continuous supply of power without interruption. (See Zeliang Shu, Shaofeng Xie and Qunzhan Li, “Single-phase back-to-back converter for active power balancing, reactive power compensation and harmonic filtering in traction power system”, IEEE Trans. on Power Electronics, Vol. 26, No. 2, February 2011, pp. 334-343.) This co-phase traction power supply system 200 includes a traction transformer 220 and an active power conditioner (APC) 240. The traction transformer 220 can use Scott transformer, YNvd transformer, V/V transformer etc. As there is no phase difference between the supplied voltages by the fraction transformers 220, the neutral sections in FIG. 1 may be replaced by section insulators 230 and the number of the section insulators 230 may be reduced to half in comparison with that of the neutral sections of the traction power supply system 100 in FIG. 1.

For the traction power supply systems in FIG. 1 and FIG. 2, a basic structure of the APC 300 is shown in FIG. 3A. The APC 300 includes a DC-AC converter 310, a dc-link 320, an AC-DC converter 330 and a coupling inductor 340. The APC 300 compensates for reactive power and filters out harmonics of traction loads via the

DC-AC converter 310. Active power is transferred by the APC via the AC-DC converter 330, the dc-link 320, the DC-AC converter 310 and coupling inductor 340, so that the current and voltage at the three-phase high-voltage power grids in FIGS. 1 and 2 are balanced. If the APC is not coupled to the output of the secondary side of the fraction transformer with a step-up coupling transformer, the voltage rating of the DC-AC converter 310 of the APC 300 have to be greater than the voltage supplied for the traction loads in order to achieve the purposes of active power transferring, reactive current compensation and harmonics suppression. The compensation of APC 300 is shown in the vector diagram in FIG. 3B, wherein V_{S} is a system voltage, I_{C} is a compensation current, V_{I} is a voltage on the coupling inductor 340 and V_{A} is an output voltage of the APC 300. Since compensation current Ic passes through the coupling inductor 340, the direction of the vector of voltage across the coupling inductor 340 is rotated 90° counter-clockwise about the vector of the compensation current I_{C}. The output voltage V_{A} of the APC 300 equals to the addition of system voltage V_{S} and the voltage V_{I} of the coupling inductor 340. That is to say, the voltage in dc-link 320 should be greater than the peak voltage supplied for the traction load. Though arranging a coupling transformer between the DC-AC converter 310 of the APC 300 and the high-voltage power grids in FIGS. 1 and 2 would reduce the voltage rating of the AC-DC converter 330, the current rating of the AC-DC converter 330 would increase proportionally. This would incur high initial costs to co-phase traction power supply system.

### SUMMARY OF THE INVENTION

It is an objective of the present invention to provide a railway power conditioner (RPC) for co-phase power supply system which has a lower rating in comparison with the conventional APCs. By applying the RPC to the co-phase power supply system, it can achieve active power balancing, reactive power compensation and harmonics suppression.

In accordance with the illustrative embodiment of the present invention, an railway power conditioner includes a DC-AC converter for performing active power injection, reactive power compensation and harmonics suppression; an AC-DC converter for performing power conversion between AC power and DC power; a DC bus coupled between said DC-AC and AC-DC converters for transferring energies; a single-phase isolation transformer connected to the AC-DC converter; a coupling capacitor connected to the DC-AC converter and a filter connected with the coupling capacitor for reducing the high-frequency components of output current of the DC-AC converter.

### BRIEF DESCRIPTION OF THE DRAWINGS

A complete understanding of the present invention may be gained by considering the following detailed description in conjunction with the accompanying drawings, in which like reference characters refer to the same parts throughout the different view.

FIG. 1 shows a schematic view of a prior art traction power supply system.

FIG. 2 shows a schematic view of another prior art co-phase traction power supply system.

FIG. 3A shows a schematic view of an active power conditioner (APC) according to the prior art.

FIG. 3B is a vector diagram to illustrate the output voltage of the DC-AC converter of APC when it injects reactive power and active power to the traction load.

FIG. 4A is a block diagram of a railway power conditioner (RPC) in accordance with this invention.

FIG. 4B is the vector diagram to illustrate the output voltage of the DC-AC converter of RPC when it injects reactive power and active power to the traction load.

FIG. 5 is a schematic view of a railway power conditioner in accordance with this invention that uses an inductor as the filter in FIG. 4A.

FIG. 6 is a schematic view of a railway power conditioner in accordance with this invention that uses an LCL filter as the filter in FIG. 4A.

FIG. 7 is a schematic view of a co-phase power supply system using a balanced feeding transformer with a railway power conditioner in accordance with this invention.

FIG. 8 is a schematic view of a co-phase power supply system using a single-phase traction transformer with a railway power conditioner in accordance with this invention.

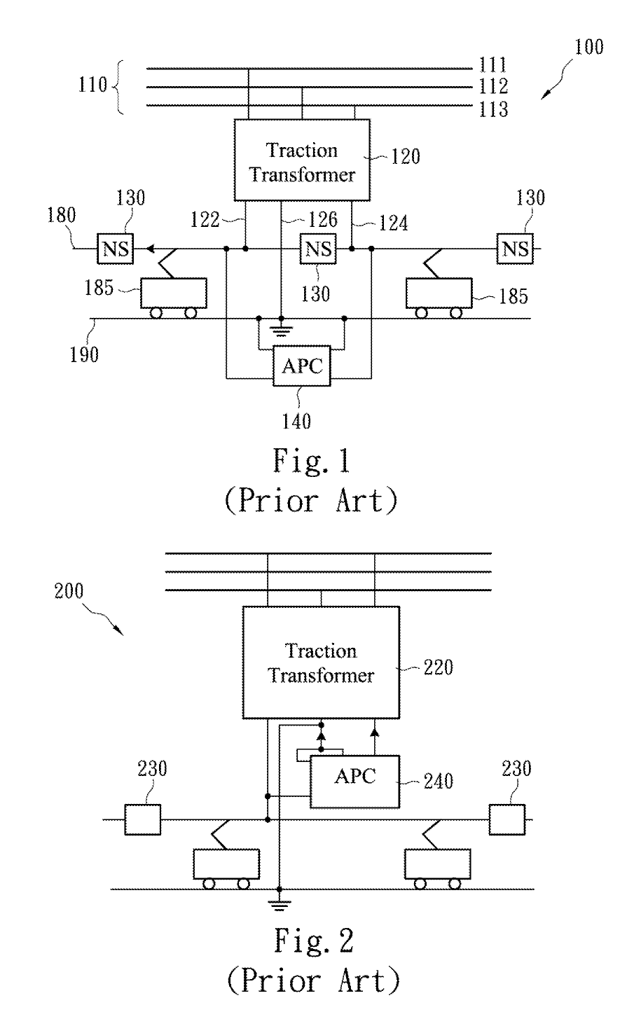

### DETAILED DESCRIPTION OF THE INVENTION

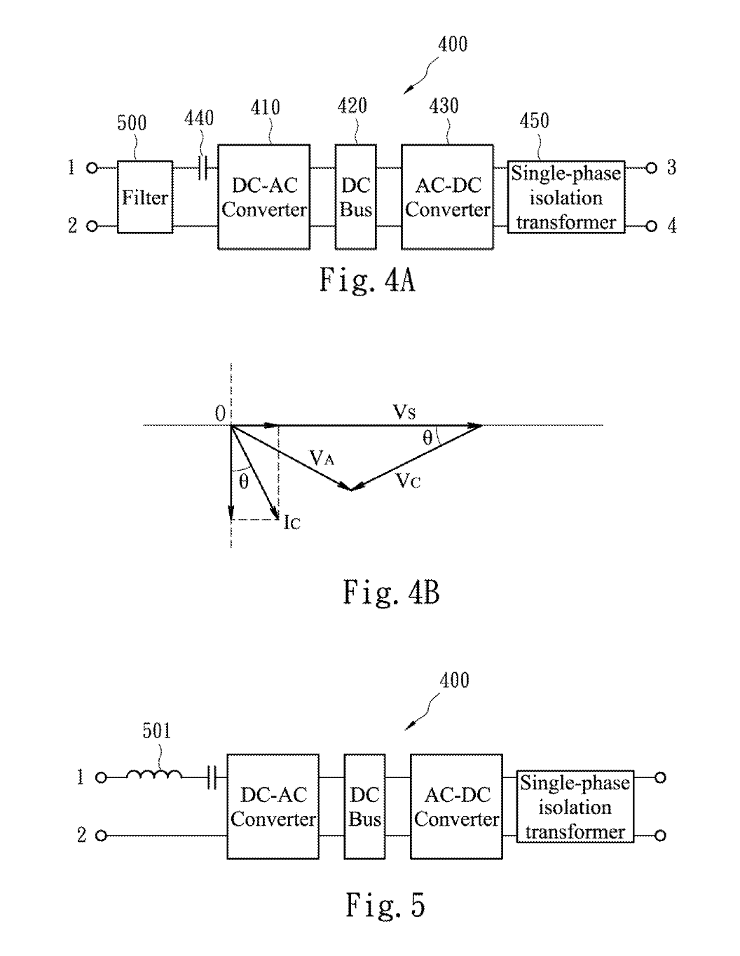

FIG. 4A is a block diagram of a railway power conditioner (RPC) 400 in accordance with this invention. The RPC 400 includes a DC-AC converter 410, an AC-DC converter 430 and a DC bus 420 connected between these two converters 410 and 430 for power exchanging. Each of the converters 410, 430 is a voltage source converter. The AC-DC converter 430 absorbs power from the high-voltage power grid to reduce the fraction power supply system unbalance and controls a voltage at the DC bus 420. The DC-AC converter 410 injects active power to support traction load; it also injects reactive currents and harmonics to the coupling points at the power supply system.

The railway power conditioner 400 further includes a filter 500 and a coupling capacitor 440 connected between the filter 500 and the DC-AC converter 410. The capacitance of the capacitor 440 is designed in terms of the required reactive power of the traction loads.

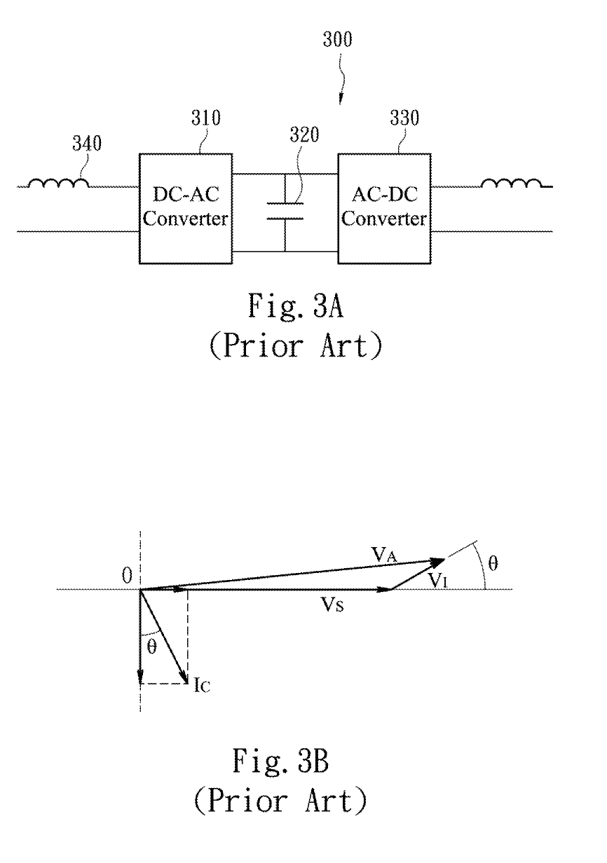

In order to inject active power to traction load, the DC-AC converter generates current in phase with the voltage. , The DC-AC converter 410 has to generate a current lagging the voltage 90 degrees due to the traction loads are inductive in order to provide reactive power compensation. The vector diagram thereof is shown in FIG. 4B. As the current passing through the coupling capacitor 440 in FIG. 4A, the corresponding voltage lags the current by 90 degrees. Therefore, when the same compensation current k as that of FIG. 3B is injected into the system, the direction of the voltage vector V_{C} resulted from the compensation current I_{C} across the coupling capacitor 440 in FIG. 4A is rotated 90° clockwise of the compensation current I_{C} such that the required output voltage of the DC-AC converter 410 can be lower than the voltage at the coupling points of the power supply system.

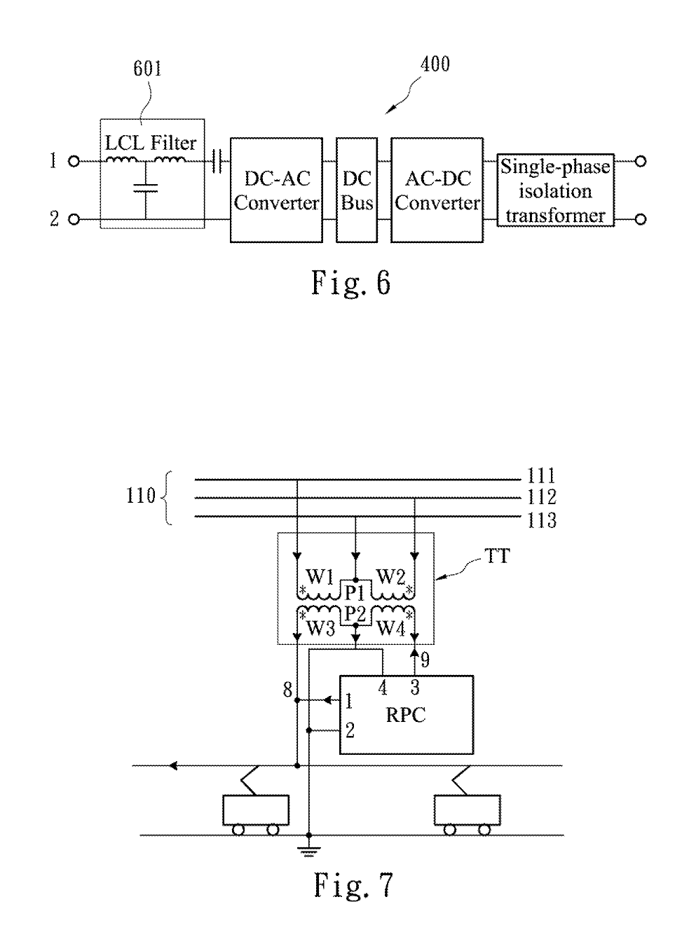

The filter 500 shown in FIG. 4A is, for example, an inductor 501 as shown in FIG. 5 or an LCL filter 601 as shown in FIG. 6. Both types of the filters reduce the high-frequency components in the output currents of the DC-AC converter.

Referring FIG. 4A, the railway power conditioner (RPC) 400 further includes a single-phase isolation transformer 450 coupling AC-DC converter 430 and receiving single-phase AC power at terminals 3 and 4 for reducing the supply voltage at the AC-DC converter 430. Otherwise, the supply voltage would be too high to achieve the power transfer. For example, the single-phase isolation transformer is a step-down transformer.

Referring FIG. 7, a fraction power supply system using the railway power conditioner (RPC) of this invention is illustrated.

The traction power supply system in a railway traction application includes a V/V fraction transformer TT including a pair of primary windings W1, W2 connected in series with a connection point P1 common to the pair of primary windings W1, W2 respectively coupled to three supply lines 111-113 of the high-voltage power grid 110 and a pair of secondary windings W3, W4 connected in series configured to provide two single-phase output supply lines 8, 9 in the railway traction system with a connection point P2 common to the secondary windings W3, W4 as a neutral.

The fraction power supply system further includes a railway power conditioner (RPC) as shown in FIG. 4A with the terminals 1 and 2 connected with the single-phase output supply line 8 of the V/V traction transformer TT and the neutral, respectively; and terminals 3 and 4 connected to the other single-phase output supply line 9 and the neutral, respectively.

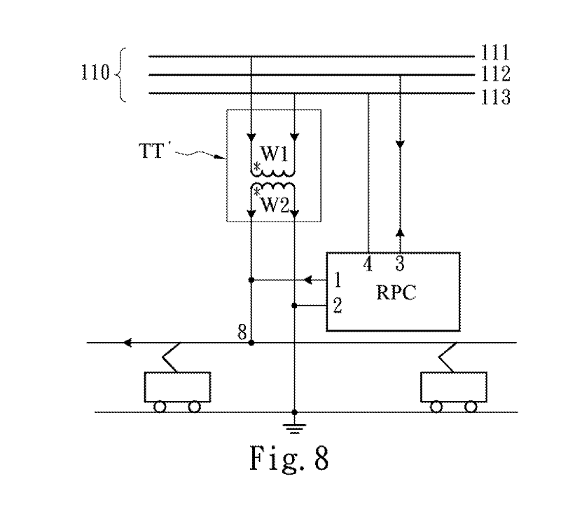

Referring to FIG. 8, a second traction power supply system using the railway power conditioner of this invention is illustrated.

The traction power supply system in a railway traction application includes a single-phase traction transformer TT′ including a primary windings W1 coupled to lines 111 and 113 of the high-voltage power grid 110 and a secondary windings W2 to provide a single-phase feeding line 8 and the neutral in the railway traction system.

The traction power supply system further includes a railway power conditioner (RPC) as shown in FIG. 4A with the terminal 1 and 2 connected with the single-phase feeding line 8 and the neutral; and the terminal 3 and 4 connected to the lines 112 and 113 of the high-voltage power grid 110, respectively.

The basic idea of this invention is to use the coupling capacitor to compensate the main part of fundamental reactive power generated by the inductive traction loads. The voltage across such coupling capacitor due to reactive power compensation has an inverse direction to the system voltage. Furthermore, the required voltage of the DC-AC converter equals the addition of system voltage and the voltage across the coupling impedance. The voltage and the rating of the DC-AC inverter can be reduced. Finally, the cost of the railway power conditioner is reduced to about 70% in comparison with that of the convention active power conditioner.

It will be apparent to those skilled in the art that various modifications and variations can be made in the device of the present invention. The present invention covers such modifications and variations which are within the scope of the appended claims and their equivalents.

What is claimed is:

1. A railway power conditioner for a railway power supply system, comprising:
a DC-AC converter for performing active power injection, reactive power compensation and harmonics suppression;
a AC-DC converter for performing power conversion between AC power and DC power;
a DC bus connected between the DC-AC converter and the AC-DC converter;
a single-phase isolation transformer coupled to the AC-DC converter; and
a coupling capacitor connected to the DC-AC converter for compensating the reactive power of the railway power supply system.

2. A railway power conditioner according to claim 1, further comprising a filter connected with the coupling capacitor for reducing the high-frequency components of output current of the DC-AC converter.

3. A railway power conditioner according to claim 2, wherein said filter is an inductor.

4. A railway power conditioner according to claim 2, wherein said filter is an LCL filter.

5. An active power conditioner according to claim 1, wherein the single-phase isolation transformer is a step-down transformer.

6. A traction power supply system, comprising:
a fraction transformer including a pair of primary windings connected in series having a connection point common to the pair of primary windings respectively coupled to three-phase supply lines of an AC power grid, and a pair of secondary windings connected in series configured to provide two single-phase output supply lines in the railway traction system with a connection point common to the secondary windings as a neutral, and
a railway power conditioner according to claim 2 with the filter connected between one of the single-phase output supply lines and the neutral and the single-phase isolation transformer connected between another of the single-phase output supply lines and the neutral.

7. A traction power supply system, comprising:
a three-phase power grid having three supply lines;
a single-phase traction transformer having a primary winding connected to the first two supply lines of three-phase power grid and a secondary winding connected to a feeding line and a neutral; and
a railway power conditioner according to claim 2 with the filter connected to the feeding line and the neutral and the single-phase isolation transformer connected the third supply line and one of the first two supply lines.
